(19) United States
(12) Patent Application Publication
(10) Pub. No.: US 2025/0117026 A1
(43) Pub. Date: Apr. 10, 2025

(54) Article Transport Facility

(71) Applicant: Daifuku Co., Ltd., Osaka-shi (JP)

(72) Inventor: Tooru Siraisi, Tokyo (JP)

(21) Appl. No.: 18/905,253

(22) Filed: Oct. 3, 2024

(30) Foreign Application Priority Data
Oct. 4, 2023 (JP) 2023-173203

(51) Int. Cl. G05D 1/695; B60L 53/14; G05D 105/28

(52) U.S. Cl. CPC G05D 1/696; B60L 53/14; G05D 2105/28

(57) ABSTRACT

An article transport facility includes a plurality of transport vehicles. In a combined state in which the plurality of transport vehicles are combined so as to be adjacent to each other, the plurality of transport vehicles constitute a transport route in which a plurality of transfer sections cooperate to transport articles. The combined transport vehicle group enters a connected state in which articles are deliverable to and from a connection target location, due to at least one transport vehicle of the combined transport vehicle group being disposed at an adjacent position adjacent to the connection target location. A control system is configured to move the combined transport vehicle group between an adjacent position adjacent to a first connection target location and an adjacent position adjacent to a second connection target location while maintaining the plurality of transport vehicles in the combined state.

### CROSS-REFERENCE TO RELATED APPLICATION

This application claims priority to Japanese Patent Application No. 2023-173203 filed Oct. 4, 2023, the disclosure of which is hereby incorporated by reference in its entirety.

### BACKGROUND OF THE INVENTION

### 1. Field of the Invention

The present invention relates to an article transport facility that includes a plurality of transport vehicles that transport articles by traveling on a travel surface without a track.

### 2. Description of Related Art

In recent years, automation of article transport has progressed in article transport facilities such as logistics warehouses. In an article transport facility of this type, for example, a transport vehicle (10) as disclosed in JP 2022-050240A (is utilized in some cases.

The transport vehicle (10) is configured to transport an article by traveling unmanned on a travel floor. The facility described in JP 2022-050240A uses a transport configuration in which a transport command is given to each of a plurality of transport vehicles (10), and each of the plurality of transport vehicles (10) transports a specific article from a transport source to a transport destination based on the transport command.

In the case of a transport configuration in which an article is transported using a transport vehicle as described in JP 2022-050240A, there is a limit to the size and number of articles that a single transport vehicle can transport, and it is also difficult to adopt a transport configuration in which a plurality of articles are transported continuously, as with a conveyor.

### SUMMARY OF THE INVENTION

In view of the above circumstances, it is desirable to realize an article transport facility that is capable of flexibly changing the transport configuration.
A technology for solving the above problem is as follows.

An article transport facility including:
a plurality of transport vehicles configured to transport an article by traveling on a travel surface without a track;
a plurality of connection target locations to which the transport vehicles are connectable; and
a control system configured to control the plurality of transport vehicles,
in which each of the transport vehicles includes
   a placement section on which the article is placeable, and
   a transfer section configured to transfer the article placed on the placement section,
in a combined state in which the plurality of transport vehicles are combined in such a manner as to be adjacent to each other, the plurality of transport vehicles constitute a transport route in which the plurality of transfer sections cooperate to transport the article,
the plurality of transport vehicles in the combined state form a combined transport vehicle group,
the combined transport vehicle group enters a connected state in which the article is deliverable to and from a connection target location of the plurality of connection target locations, due to at least one of the plurality of transport vehicles in the combined transport vehicle group being disposed at an adjacent position adjacent to the connection target location,
the plurality of connection target locations include a first connection target location and a second connection target location at a position different from that of the first connection target location, and
the control system is configured to move the combined transport vehicle group between the adjacent position adjacent to the first connection target location and the adjacent position adjacent to the second connection target location while maintaining the plurality of transport vehicles in the combined state.

According to this configuration, each transport vehicle can transport an article to various locations alone, and a plurality of transport vehicles can be combined to transport an article along a continuous transport route. That is, it is possible to use the transport vehicles to realize a transport configuration in which a specific article is transported to a specific location and a transport configuration in which a plurality of articles are continuously transported to the same location. Furthermore, the combined transport vehicle group can use the placement sections of the plurality of transport vehicles that constitute the combined transport vehicle group to place articles of a size or number that cannot be transported by a single transport vehicle. The combined transport vehicle group can then move between the plurality of connection target locations while maintaining the combined state. Accordingly, articles of a size or number that cannot be transported by a single transport vehicle can be transported between a plurality of connection target locations. As described above, according to the present configuration, it is possible to flexibly change the article transport configuration.

Further features and advantages of the techniques disclosed herein will become more apparent from the following description of exemplary and non-limiting embodiments, which are described with reference to the drawings.

### BRIEF DESCRIPTION OF THE DRAWINGS

FIG. 1 is a plan view of an article transport facility.

FIG. 2 is a control block diagram.

FIG. 3 is a diagram showing how an article is transferred between a transport vehicle and a transfer target location.

FIG. 4 is a diagram showing a transfer structure of the transport vehicle.

FIG. 5 is a diagram showing a travel structure of the transport vehicle.

FIG. 6 is a schematic plan view of the transport vehicle.

FIG. 7 is a diagram showing a combined state of a plurality of transport vehicles.

FIG. 8 is a diagram showing one mode of a combined transport vehicle group.

FIG. 9 is a diagram showing how the combined transport vehicle group connects to a connection target location.

FIG. 10 is a diagram showing an example of a transport configuration using a plurality of transport vehicles in a combined state.

FIG. 11 is a diagram showing an example of a transport configuration using a plurality of transport vehicles in a combined state.

FIG. 12 is a diagram showing an example of a transport configuration using a plurality of transport vehicles in a combined state.

FIG. 13 is a diagram showing how the combined transport vehicle group receives a supply of power from a power supply section.

FIG. 14 is a diagram showing an example of a transport configuration using a plurality of transport vehicles in a combined state.

### DESCRIPTION OF THE INVENTION

Hereinafter, an embodiment of an article transport facility will be described with reference to the drawings.

Note that in this specification, “transferring an article” means delivering or receiving an article to or from a transfer target location. “Transporting an article” means moving an article toward a destination, or in other words, carrying an article.

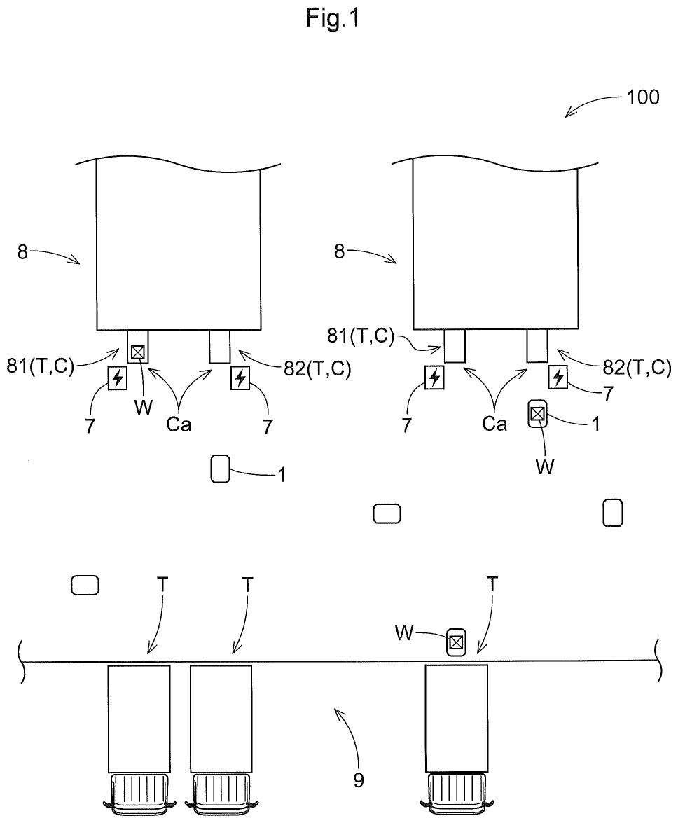

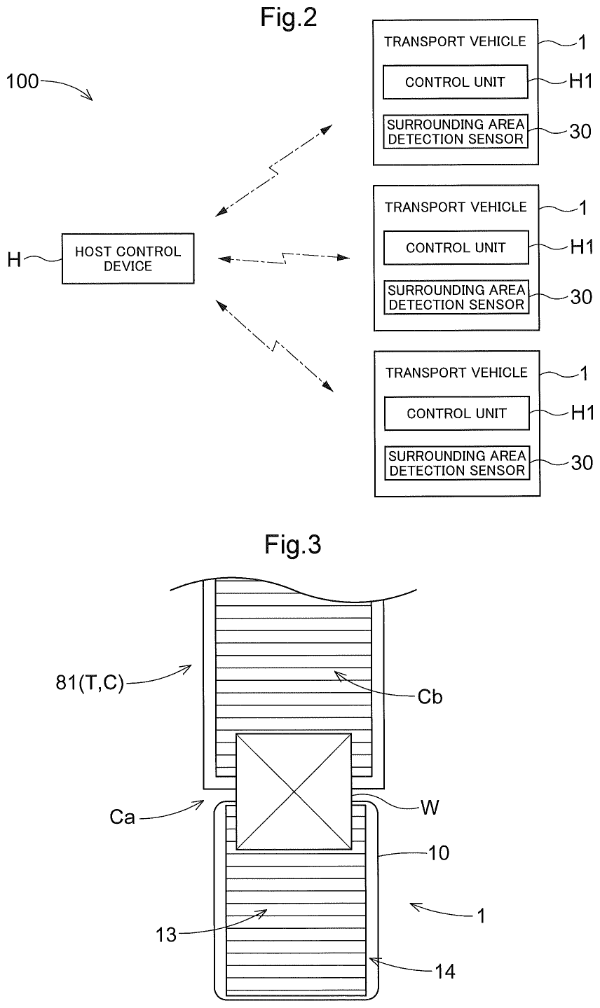

As shown in FIG. 1, an article transport facility 100 includes a plurality of transport vehicles 1 that transport articles W by traveling on a travel surface without a track, a plurality of connection target locations C to which the transport vehicles 1 are to be connected, and a host control device H (see FIG. 2) that controls the plurality of transport vehicles 1. In this embodiment, the article transport facility 100 is provided with a power supply section 7 that supplies power to the transport vehicles 1 while fixed at a position on the travel surface. In the illustrated example, a plurality of power supply sections 7 are provided in the article transport facility 100.

The travel surface is, for example, the floor surface of the article transport facility 100. “Traveling without a track” means traveling without using a track such as a rail. Accordingly, the transport vehicles 1 can travel freely on the floor surface of the article transport facility 100 without being bound by a track such as a rail. For example, it is possible to use a configuration in which a plurality of detection objects, such as two-dimensional codes or RF (Radio Frequency) tags, are installed on the floor surface, and the transport vehicles 1 travel along routes connecting the plurality of detection objects. It is also possible to use a configuration in which a detection object of this type is not provided on the floor surface, and the transport vehicles 1 travel along a route calculated based on a result of recognizing the surrounding environment.

A plurality of transfer target locations T to which articles W are to be transferred are set in the article transport facility 100. The article transport facility 100 of this embodiment includes a receiving and shipping area 9 where receiving and shipping of the articles W is performed between the inside and outside of the facility, and automated warehouses 8 provided inside the facility.

The receiving and shipping area 9 is, for example, a truck berth. A plurality of transfer target locations T are set in the receiving and shipping area 9. The articles W to be received or the articles W to be shipped are transferred by a forklift or conveyor (not shown), or by a transport vehicle 1 at a transfer target location T in the receiving and shipping area 9.

In this embodiment, a plurality of automated warehouses 8 are provided inside the facility. Each of the plurality of automated warehouses 8 includes storage shelves (not shown) for storing articles W, a loading section 81 for loading articles W into the storage shelves, an unloading section 82 for unloading articles W from the storage shelves, and an in-shelf transport device (not shown) for transporting articles W within the storage shelves. Examples of the in-shelf transport device include a stacker crane, a lifter, a conveyor, and a transport cart.

In this embodiment, the transfer target locations T include the loading section 81 and the unloading section 82. The transport vehicle 1 connects to the loading section 81 in the case of transferring an article W between the transport vehicle 1 and the loading section 81 (see also FIG. 3). Similarly, the transport vehicle 1 connects to the unloading section 82 in the case of transferring an article W between the unloading section 82 and the transport vehicle 1. In this way, the loading section 81 and the unloading section 82 are connection target locations C to which the transport vehicle 1 is to be connected. That is, in this embodiment, the loading section 81 and the unloading section 82 are the transfer target locations T, and are also the connection target locations C.

The connection target location C includes a conveyor Cb (see also FIG. 3). The loading section 81 and the unloading section 82 serving as the connection target locations C are constituted using the conveyors Cb in this embodiment. Examples of a conveyor Cb of this type include a roller conveyor, a belt conveyor, and a chain conveyor.

As shown in FIG. 2, the article transport facility 100 of this embodiment includes a host control device H that controls the plurality of transport vehicles 1. The host control device H can communicate with the plurality of transport vehicles 1. The host control device H is configured to transmit to each transport vehicle 1, for example, a transport command designating a specific article W, a transport source, and a transport destination. The transport vehicle 1 is configured to transport an article W based on a transport command upon receiving the transport command. The host control device H of this specification corresponds to a “control system”. However, it is sufficient that the host control device H constitutes at least a part of the control system. For example, in addition to the host control device H, a control device other than the host control device H, a control unit H1 (described later) provided for the transport vehicle 1, and the like may be used to constitute the “control system”. Also, instead of providing the host control device H, a plurality of control units H1 that are communicatively connected to each other may cooperate to constitute a control system.

The transport vehicle 1 includes a control unit H1 that controls the transport vehicle 1. The control unit H1 is configured to control each functional unit included in the transport vehicle 1. The functional units of the transport vehicle 1 include a functional unit for traveling, a functional unit for transferring an article W, a functional unit for communication, and the like. The control unit H1 is configured to control the transport vehicle 1 in such a manner as to transport an article W from a designated transport source to a transport destination based on a transport command from the host control device H.

The host control device H and the control unit H1 each include, for example, a processor such as a microcomputer, peripheral circuits such as a memory, and the like. Each function is realized by cooperation between these pieces of hardware and a program to be executed on a processor of a computer or the like.

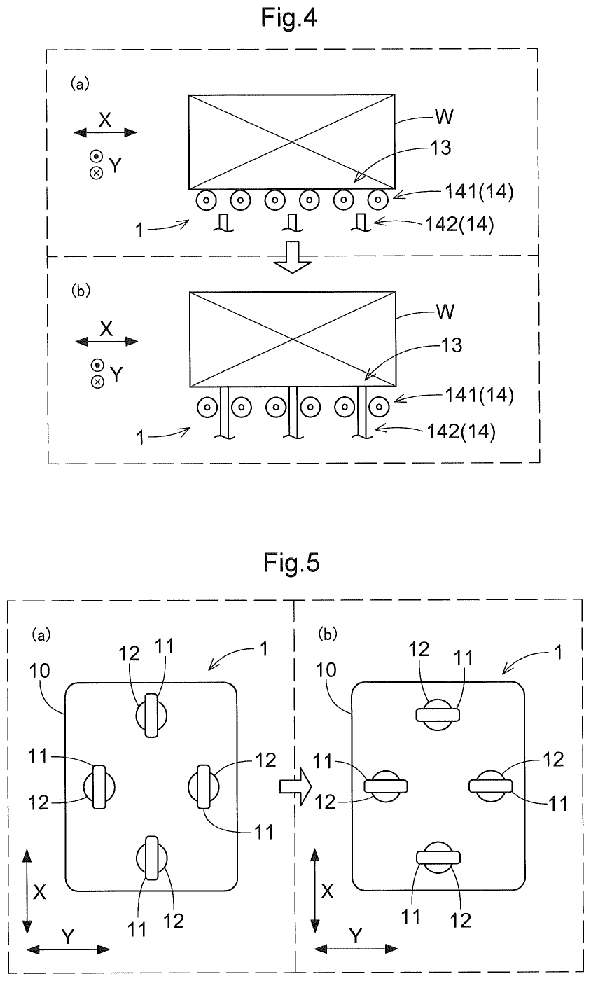

As shown in FIGS. 3 and 4, the transport vehicle 1 includes a placement section 13 on which an article W is placed, and a transfer section 14 that transfers an article W placed on the placement section 13 between the transport vehicle 1 and the transfer target location T. FIG. 3 shows how the transport vehicle 1 transfers an article W between the transport vehicle 1 and the loading section 81 serving as the transfer target location T. As shown in FIG. 3, the transport vehicle 1 is configured to deliver an article W placed on the placement section 13 to the loading section 81 (transfer target location T) by using the transfer section 14. Note that when the transport vehicle 1 transfers an article W between the transport vehicle 1 and the unloading section 82 serving as the transfer target location T, the above is reversed. That is, the transport vehicle 1 is configured to receive an article W placed in the unloading section 82 (the transfer target location T) by using the transfer section 14.

As shown in FIG. 4, the transfer section 14 of this embodiment includes a first transfer mechanism 141 that moves an article W on the placement section 13, and a second transfer mechanism 142 that moves an article W in a direction different from that of the first transfer mechanism 141. All or some of the plurality of transport vehicles 1 included in the article transport facility 100 are equipped with a transfer section 14 including a first transfer mechanism 141 and second transfer mechanism 142 of this type.

The first transfer mechanism 141 of this embodiment is configured to move an article W along a body front-rear direction X. In the illustrated example, the first transfer mechanism 141 is constituted using a roller conveyor. The rollers constituting the roller conveyor are arranged side by side in the body front-rear direction X, while extending in a body width direction Y.

The second transfer mechanism 142 of this embodiment is configured to move the article W along the body width direction Y. That is, the first transfer mechanism 141 and the second transfer mechanism 142 of this example are configured to move an article W along directions perpendicular to each other in a view in the up-down direction.

In this embodiment, the second transfer mechanism 142 is constituted using a conveyor having a plurality of chains or belts. The plurality of chains or belts (three belts in the illustrated example) are arranged between the rollers constituting the first transfer mechanism 141.

The second transfer mechanism 142 is configured to move up and down between a storage position located below the first transfer mechanism 141 and a protruding position located above the first transfer mechanism 141. The second transfer mechanism 142 is stored inside the transport vehicle 1 when in the storage position. In this state, the article W is supported by the first transfer mechanism 141, and the article W can be transferred by the first transfer mechanism 141 (see FIG. 4A). Also, the second transfer mechanism 142 protrudes above the first transfer mechanism 141 when in the protruding position. In this state, the article W is supported by the second transfer mechanism 142, and the article W can be transferred by the second transfer mechanism 142 (see FIG. 4B).

As shown in FIG. 5, the transport vehicle 1 includes a body 10 and a plurality of wheels 11 supported by the body 10. At least one of the plurality of wheels 11 is driven by a drive source such as a motor. This provides the transport vehicle 1 with a propulsive force.

In this embodiment, the transport vehicle 1 includes turning mechanisms 12 that turn each wheel 11 about a vertical axis. Each of the plurality of wheels 11 is supported on the body 10 via a turning mechanism 12. The turning mechanisms 12 orient the rotation axes of the wheels 11 in the body width direction Y, whereby the transport vehicle 1 assumes a first travel orientation in which it is possible to travel in the body front-rear direction X (see FIG. 5A). The turning mechanisms 12 orient the rotation axes of the wheels 11 in the body front-rear direction X, whereby the transport vehicle 1 assumes a second travel orientation in which it is possible to travel in the body width direction Y (see FIG. 5B). Note that the transport vehicle 1 can basically travel lengthwise and widthwise on the travel surface by, for example, changing its direction while in the first travel orientation.

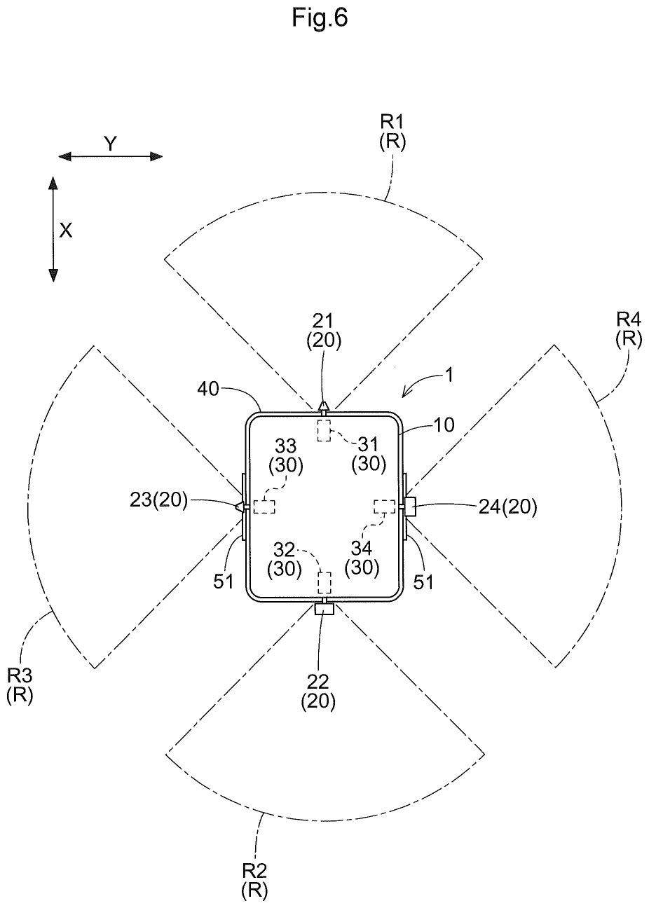

As shown in FIG. 6, the transport vehicle 1 includes surrounding area detection sensors 30. The control unit H1 (see FIG. 2) of the transport vehicle 1 is configured to stop or decelerate the transport vehicle 1 in response to an obstacle being detected in the surrounding area of the transport vehicle 1 by the surrounding area detection sensors 30 while the transport vehicle 1 is traveling. An example of an obstacle detected by the surrounding area detection sensor 30 is another transport vehicle 1. This makes it possible to avoid collisions between transport vehicles 1 traveling unmanned. Examples of the surrounding area detection sensors 30 include optical sensors, ultrasonic sensors, LiDAR (Light Detection And Ranging), sonar sensors, and millimeter wave radars.

The surrounding area detection sensors 30 of this embodiment are configured to detect an obstacle in each of a front range R1, a rear range R2, a left range R3, and a right range R4 of the transport vehicle 1, which are defined as detection ranges R. The surrounding area detection sensors 30 of this example include a front sensor 31 that performs detection in the front range R1 of the transport vehicle 1, a rear sensor 32 that performs detection in the rear range R2 of the transport vehicle 1, a left sensor 33 that performs detection in the left range R3 of the transport vehicle 1, and a right sensor 34 that performs detection in the right range R4 of the transport vehicle 1. That is, in this example, the transport vehicle 1 includes at least four surrounding area detection sensors 30.

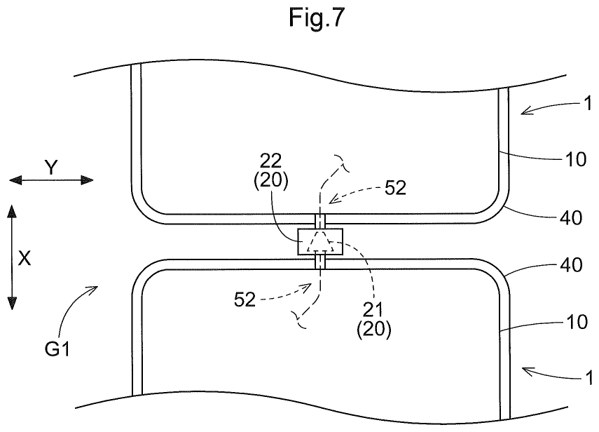

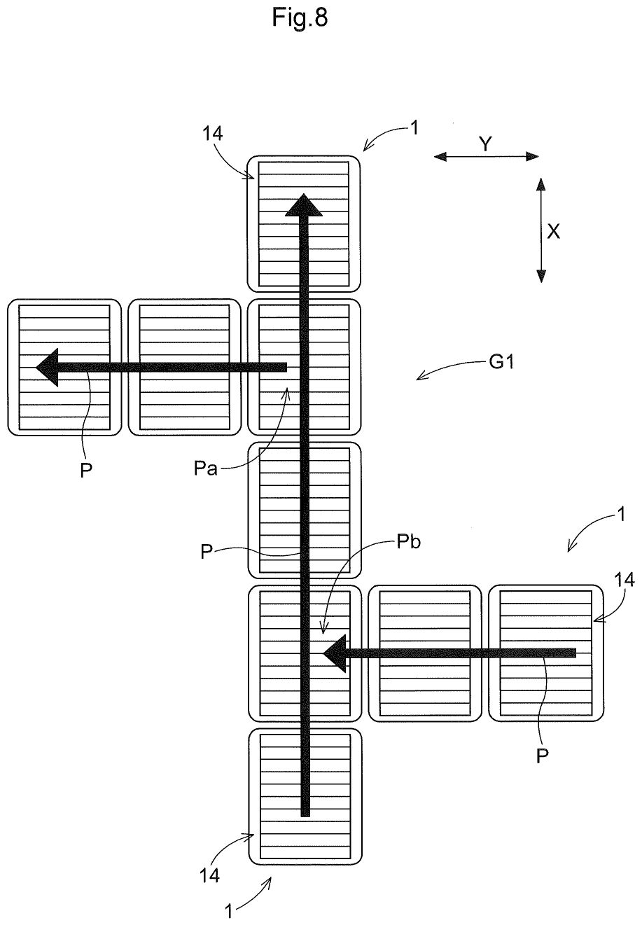

As shown in FIG. 7, a plurality of transport vehicles 1 can combine with each other. In a combined state in which the plurality of transport vehicles 1 are adjacent to each other, the plurality of transport vehicles 1 constitute a transport route P in which the plurality of transfer sections 14 cooperate to transport the articles W (see FIG. 8). Each transport vehicle 1 in the article transport facility 100 according to the present disclosure is configured to transport an article W to various locations alone in the case of traveling alone. That is, a transport configuration can be realized in which a specific article W is transported to a specific location. In addition, the plurality of transport vehicles 1 are configured to transport articles W along a continuous transport route P by combining with each other. That is, a transport configuration can be realized in which a plurality of articles W are transported continuously to the same location. In this specification, a plurality of transport vehicles 1 in the combined state are defined as a combined transport vehicle group G1.

As shown in FIGS. 6 and 7, the transport vehicle 1 of this embodiment further includes coupling sections 20 for coupling with another transport vehicle 1. The coupling sections 20 are provided on the body 10 and protrude from the body 10 in a view in the up-down direction. The transport vehicle 1 and a combination target vehicle 1, which is another transport vehicle 1, are configured to enter a combined state by being coupled to each other by the coupling sections 20 (see FIG. 7).

The transport vehicle 1 of this embodiment has, as the coupling sections 20, a front coupling section 21 provided for a front part of the transport vehicle 1, a rear coupling section 22 provided for a rear part of the transport vehicle 1, a left coupling section 23 provided for a left part of the transport vehicle 1, and a right coupling section 24 provided for a right part of the transport vehicle 1.

The front coupling section 21 of the transport vehicle 1 is configured to couple with the rear coupling section 22 of the combination target vehicle 1, and the rear coupling section 22 of the transport vehicle 1 is configured to couple with the front coupling section 21 of the combination target vehicle 1. The front coupling section 21 and the rear coupling section 22 of this embodiment have shapes corresponding to each other and are configured to engage with each other. The front coupling section 21 of this example has a tapered insertion portion. The rear coupling section 22 has a hole into which the insertion portion of the front coupling section 21 is inserted. The insertion portion of the front coupling section 21 is inserted into the hole of the rear coupling section 22, whereby the front coupling section 21 and the rear coupling section 22 are coupled to each other.

The left coupling section 23 of the transport vehicle 1 is configured to couple with the right coupling section 24 of the combination target vehicle 1, and the right coupling section 24 of the transport vehicle 1 is configured to couple with the left coupling section 23 of the combination target vehicle 1. The left coupling section 23 and the right coupling section 24 of this embodiment have shapes corresponding to each other and are configured to engage with each other. The left coupling section 23 of this example has a tapered insertion portion. The right coupling section 24 has a hole into which the insertion portion of the left coupling section 23 is inserted. The insertion portion of the left coupling section 23 is inserted into the hole of the right coupling section 24, whereby the left coupling section 23 and the right coupling section 24 are coupled to each other.

In this way, each transport vehicle 1 can be combined with other transport vehicles 1, and by combining them, a continuous transport route P can be formed. However, as described above, each transport vehicle 1 includes the surrounding area detection sensors 30 as a collision prevention means, and the transport vehicle 1 stops or decelerates in response to an obstacle being present within the detection range R of the surrounding area detection sensors 30. For this reason, the combination target vehicle 1 that is to be combined with the transport vehicle 1 is detected as an obstacle by the surrounding area detection sensor 30 before the combination. In this case, the collision prevention means using the surrounding area detection sensors 30 prevents the transport vehicles 1 from combining with each other.

In view of this, as shown in FIG. 7, the control unit H1 (see FIG. 2) of the transport vehicle 1 of this embodiment is configured to at least partially disable the surrounding area detection sensors 30 so as not to detect a combination target vehicle 1 that is another transport vehicle 1 that is a combination target, while the transport vehicle 1 performs a combining operation with the combination target vehicle 1. This makes it possible to prevent the partially disabled surrounding area detection sensors 30 from detecting the combination target vehicle 1 as an obstacle. Accordingly, the transport vehicle 1 and the combination target vehicle 1 can be combined appropriately.

The control unit H1 of the transport vehicle 1 of this embodiment is configured to disable detection in at least the detection range R on the side where the combination target vehicle 1 is present among the plurality of detection ranges R, while the transport vehicle 1 performs a combining operation with the combination target vehicle 1. In the example shown in FIG. 7, the control unit H1 of the transport vehicle 1 disables detection by the surrounding area detection sensor 30 in the front range R1 (see FIG. 6) while performing a combining operation with the combination target vehicle 1 in front of the transport vehicle 1. The combination target vehicle 1 also disables detection by the surrounding area detection sensor 30 in the rear range R2 (see FIG. 6).

Note that partial disabling of the surrounding area detection sensors 30 is performed not only while a plurality of transport vehicles 1 perform a combining operation, but also while the transport vehicle 1 transfers an article W between the transport vehicle 1 and a transfer target location T, as shown in FIG. 3, for example.

The transport vehicle 1 and the combination target vehicle 1 of this embodiment are configured to perform a combining operation by approaching each other or by one approaching the other. The coupling sections 20 of the transport vehicle 1 and the combination target vehicle 1 are coupled to each other and the transport vehicle 1 and the combination target vehicle 1 enter a combined state due to the transport vehicle 1 and the combination target vehicle 1 relatively approaching each other.

The transport vehicle 1 and the combination target vehicle 1 of this embodiment can be combined in the body front-rear direction X. For example, the transport vehicle 1 and the combination target vehicle 1 are combined in the body front-rear direction X due to the front coupling section 21 of the transport vehicle 1 and the rear coupling section 22 of the combination target vehicle 1 coupling to each other (see FIG. 7). At this time, the front sensor 31 of the transport vehicle 1 is disabled, and the rear sensor 32 of the combination target vehicle 1 is also disabled. In addition, the travel orientation of at least either the transport vehicle 1 or the combination target vehicle 1 (the one approaching the other) becomes a first travel orientation (see FIG.

5A) while the transport vehicle 1 and the combination target vehicle 1 perform a combining operation of combining in the body front-rear direction X. This allows the transport vehicle 1 and the combination target vehicle 1 to relatively approach each other in the body front-rear direction X to appropriately combine the two vehicles in the body front-rear direction X.

The transport vehicle 1 and the combination target vehicle 1 of this embodiment can be combined in the body width direction Y. For example, the transport vehicle 1 and the combination target vehicle 1 are combined in the body width direction Y due to the left coupling section 23 of the transport vehicle 1 and the right coupling section 24 of the combination target vehicle 1 coupling with each other. At this time, the left sensor 33 of the transport vehicle 1 is disabled, and the right sensor 34 of the combination target vehicle 1 is disabled. Also, the travel orientation of at least either the transport vehicle 1 or the combination target vehicle 1 (the one approaching the other) becomes the second travel orientation (see FIG. 5B) while the transport vehicle 1 and the combination target vehicle 1 perform a combining operation of combining in the body width direction Y. This allows the transport vehicle 1 and the combination target vehicle 1 to relatively approach each other along the body width direction Y to appropriately combine the two vehicles in the body width direction Y.

A plurality of transport vehicles 1 may link with each other by emitting and receiving optical signals to and from each other while performing a combining operation. Alternatively, linking may be performed through short-distance wireless communication instead of emitting and receiving optical signals. Alternatively, linking may be performed based on the position information of the transport vehicles 1 that the host control device H keeps track of.

As shown in FIGS. 6 and 7, the transport vehicle 1 of this embodiment includes, in addition to the surrounding area detection sensors 30, a contact sensor 40 that detects that a contacting object has come into contact with the transport vehicle 1. As a result, the contact sensor 40 can detect a contacting object contacting the body 10 even if the surrounding area detection sensors 30 are disabled. For example, it is possible to stop the transport vehicles 1 in response to the transport vehicles 1 not being appropriately coupled to each other and the bodies 10 coming into contact with each other.

In this embodiment, the contact detection range of the contact sensor 40 is set to the entire outer periphery of the body 10 of the transport vehicle 1. In other words, the detection unit of the contact sensor 40 is provided around the entire outer periphery of the body 10 of the transport vehicle 1. For example, the contact sensor 40 is constituted using a bumper sensor.

As shown in FIG. 7, a gap is formed between the contact sensors 40 of adjacent transport vehicles 1 while a plurality of transport vehicles 1 are combined. That is, a gap is formed between adjacent transport vehicles 1 while a plurality of transport vehicles 1 are combined. As a result, the bodies 10 or the contact sensors 40 of the adjacent transport vehicles 1 in the combined state do not come into contact with each other. Accordingly, the above configuration can prevent the transport vehicles 1 from being detected erroneously by the contact sensors 40 while the plurality of transport vehicles 1 are combined.

Each of the plurality of transport vehicles 1 of this embodiment includes a power transmission section 52 that transmits power to the other transport vehicles 1 while combined with the other transport vehicles 1. A power line of the power transmission section 52 of this example is provided in the coupling section 20. Terminals of the power transmission sections 52 of the transport vehicles 1 are connected to each other while the transport vehicles 1 to be combined are coupled to each other via their coupling sections 20. As a result, the transport vehicles 1 to be combined are electrically connected to each other via their respective power transmission sections 52.

As described above, the article transport facility 100 is provided with the power supply sections 7 that supply power to the transport vehicles 1 (see FIG. 1). As shown in FIG. 6, the transport vehicle 1 includes a power reception section 51 for receiving a supply of power from the power supply section 7. The power reception section 51 of this example is constituted using a power reception pad, and the transport vehicle 1 is configured to receive a supply of power in a non-contacting manner from the power supply section 7 that includes a power transmission pad. The power reception section 51 is provided on the body 10 of the transport vehicle 1. In the illustrated example, the power reception section 51 is provided on each side of the body 10 in the body width direction Y. However, the power reception section 51 may alternatively be provided on only one side of the body 10 in the body width direction Y.

FIG. 8 shows one mode of a combined transport vehicle group G1. As described above, the combined transport vehicle group G1 forms a transport route P for the article W. The host control device H of this embodiment (see FIG. 2) is configured to selectively cause the combined transport vehicle group G1 to form a serial configuration in which the transport route P is a single route, a branching configuration in which at least one location on the transport route P is provided with a branching section Pa where one route branches into two or more routes, and a merging configuration in which at least one location on the transport route P is provided with a merging section Pb where two or more routes merge into one route. The host control device H is configured to control the combined transport vehicle group G1 so as to form each of the serial configuration, the branching configuration, and the merging configuration independently, or to form a combination of these configurations. In the example shown in FIG. 8, the transport route P formed by the combined transport vehicle group G1 has a configuration including all of the serial configuration, the branching configuration, and the merging configuration. Note that the serial configuration may be linear, or may be bent in an L-shape or gently bent in a U-shape. The serial configuration may also be a ring shape with no end portions.

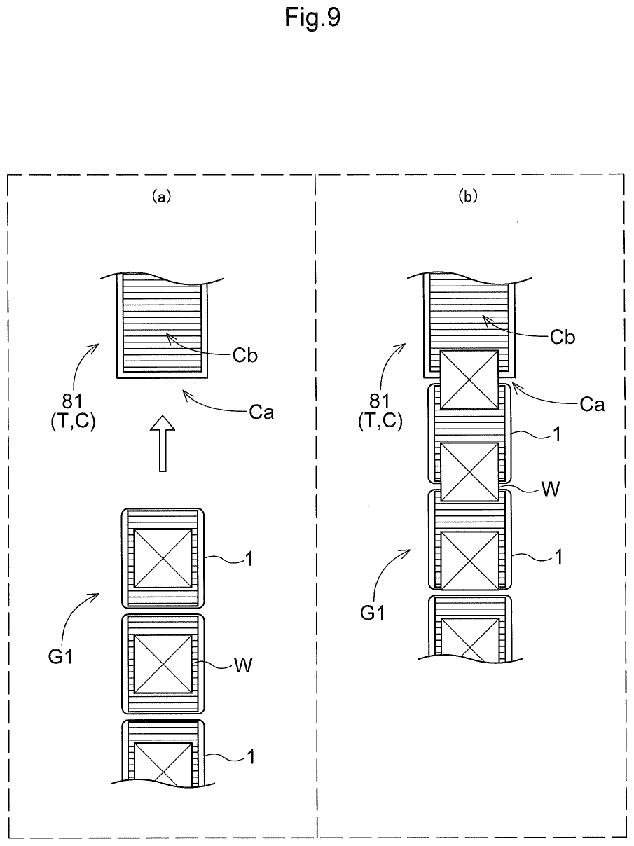

As shown in FIG. 9, the combined transport vehicle group G1 enters a connected state in which articles W can be delivered to and from the connection target location C due to at least one transport vehicle 1 of the combined transport vehicle group G1 being disposed at an adjacent position Ca adjacent to the connection target location C. In this example, the transport vehicle 1 at at least one end of the combined transport vehicle group G1 (in other words, the transport vehicle 1 constituting at least one end of the transport route P) is disposed at the adjacent position Ca. In this example, a gap is formed between the transport vehicle 1 disposed at the adjacent position Ca and the connection target location C while the combined transport vehicle group G1 is in the connected state. That is, the transport vehicle 1 disposed at the adjacent position Ca and the connection target location C are not physically coupled to each other. This allows the combined transport vehicle group G1 to smoothly connect to and disconnect from the connection target location C.

In FIG. 9, the loading section 81 is illustrated as an example of the connection target location C. As described above, the connection target location C includes the conveyor Cb. In this embodiment, when the combined transport vehicle group G1 is to be put in the connected state, the host control device H disposes at least one transport vehicle 1 of the combined transport vehicle group G1 at the adjacent position Ca by moving the combined transport vehicle group G1 to approach the adjacent position Ca along the conveyor transport direction, which is the direction in which the conveyor Cb transports the article W. In this example, the combined transport vehicle group G1 is moved to approach the adjacent position Ca as described above, whereby the transport vehicle 1 at one end of the combined transport vehicle group G1 is disposed at the adjacent position Ca. This makes it easy to appropriately align the direction in which the article W is transported by the conveyor Cb at the connection target location C with the direction in which the article W is transported by each transport vehicle 1 that constitutes the combined transport vehicle group G1. For example, by starting to transport an article W on the combined transport vehicle group G1 before the combined transport vehicle group G1 connects to the connection target location C, it is possible to deliver the article W to the conveyor Cb at the connection target location C immediately after the combined transport vehicle group G1 connects to the connection target location C. In this example, the combined transport vehicle group G1 moves along the conveyor transport direction at least within a range of a predetermined distance or less from the adjacent position Ca. Note that when the combined transport vehicle group G1 moves away from the adjacent position Ca, the combined transport vehicle group G1 may move along the conveyor transport direction, a direction perpendicular to the conveyor transport direction, or a direction oblique to the conveyor transport direction.

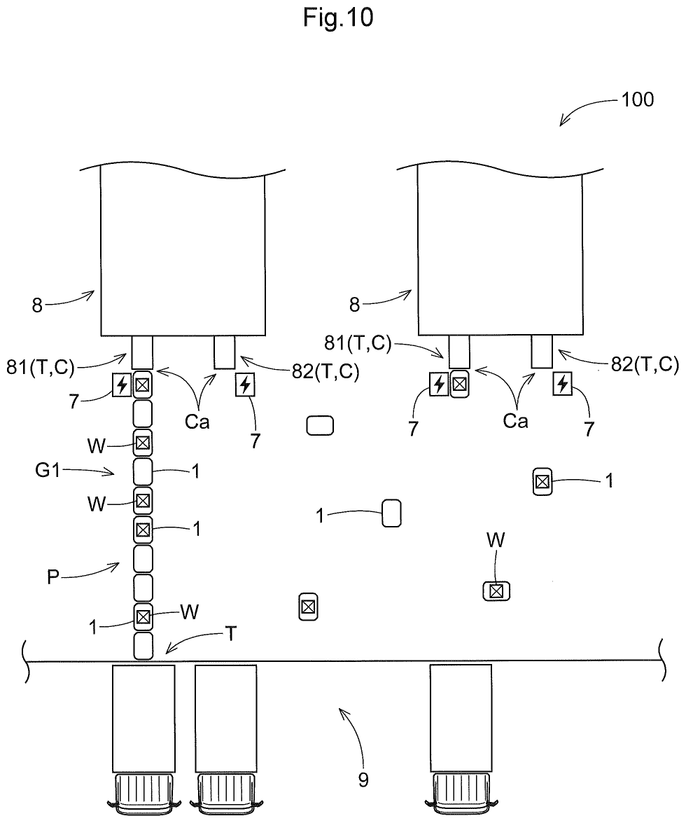

FIG. 10 shows an example of a transport configuration using a plurality of transport vehicles 1 in the combined state. As described above, a plurality of transport vehicles 1 are combined to form a combined transport vehicle group G1, thereby forming a continuous transport route P. This makes it possible to continuously transport a plurality of articles W along the transport route P. That is, due to the plurality of transport vehicles 1 entering the combined state to form a transport route P connecting different transfer target locations T, a plurality of articles W can be transported continuously between the different transfer target locations T. In this manner, the article transport facility 100 according to the present disclosure can realize a transport configuration in which a plurality of articles W are continuously transported to the same location.

In the example shown in FIG. 10, a plurality of transport vehicles 1 are combined to form a transport route P connecting the receiving and shipping area 9 to the automated warehouse 8. In other words, the combined transport vehicle group G1 connects the receiving and shipping area 9 to the automated warehouse 8. In this example, a plurality of transport vehicles 1 are arranged side by side in a line to form a single transport route P and to constitute a combined transport vehicle group G1. This allows a plurality of articles W to be transported continuously from the receiving and shipping area 9 to the automated warehouse 8.

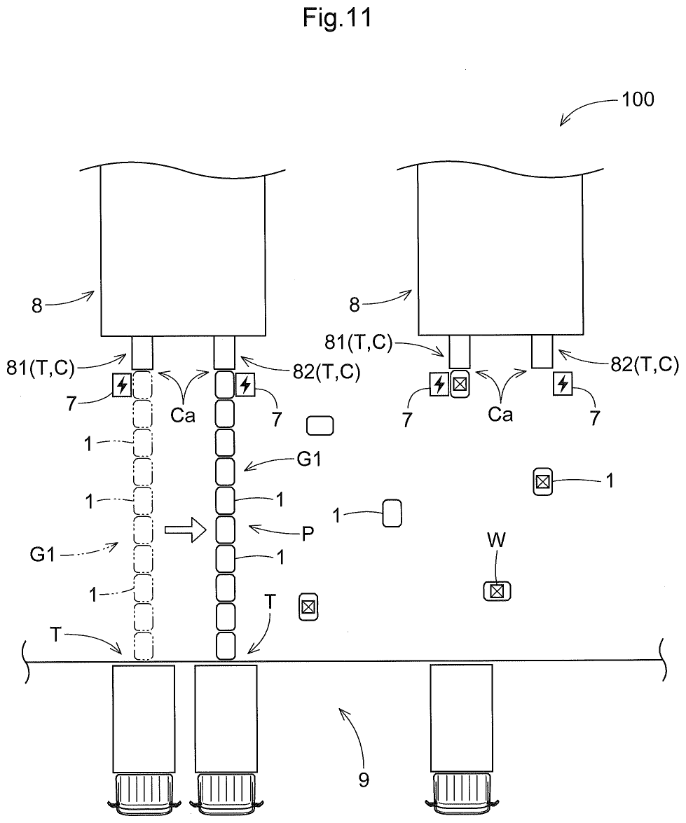

As shown in FIG. 11, the host control device H is configured to move the combined transport vehicle group G1 between a plurality of connection target locations C while maintaining the plurality of transport vehicles 1 in the combined state. In the illustrated example, the host control device H moves the combined transport vehicle group G1 from the loading section 81 to the unloading section 82 of the automated warehouse 8 while maintaining the plurality of transport vehicles 1 in the combined state. This allows the combined transport vehicle group G1 to continuously load a plurality of articles W in the automated warehouse 8, and then to continuously unload a plurality of articles W to be unloaded from the automated warehouse 8.

Here, the combined transport vehicle group G1 can use the placement sections 13 (see FIG. 3) of the plurality of transport vehicles 1 that constitute the combined transport vehicle group G1 to place articles W of a size or number that cannot be transported by a single transport vehicle 1. As described above, the combined transport vehicle group G1 can move between the plurality of connection target locations C while maintaining the combined state. Accordingly, it is possible to transport articles W of a size or number that cannot be transported by a single transport vehicle 1 between a plurality of connection target locations C. Also, with the above-described configuration, the combined transport vehicle group G1 can move between a plurality of different connection target locations C in a shorter time than when the transport vehicles 1 move independently to the desired connection target location C and then combine with each other to form the combined transport vehicle group G1.

Note that in order to distinguish between two connection target locations C arranged at different positions, one can be defined as a first connection target location and the other can be defined as a second connection target location. That is, the plurality of connection target locations C include a first connection target location and a second connection target location arranged at a position different from the first connection target location, and the host control device H is configured to move the combined transport vehicle group G1 between an adjacent position Ca adjacent to the first connection target location and an adjacent position Ca adjacent to the second connection target location while maintaining the plurality of transport vehicles 1 in a combined state.

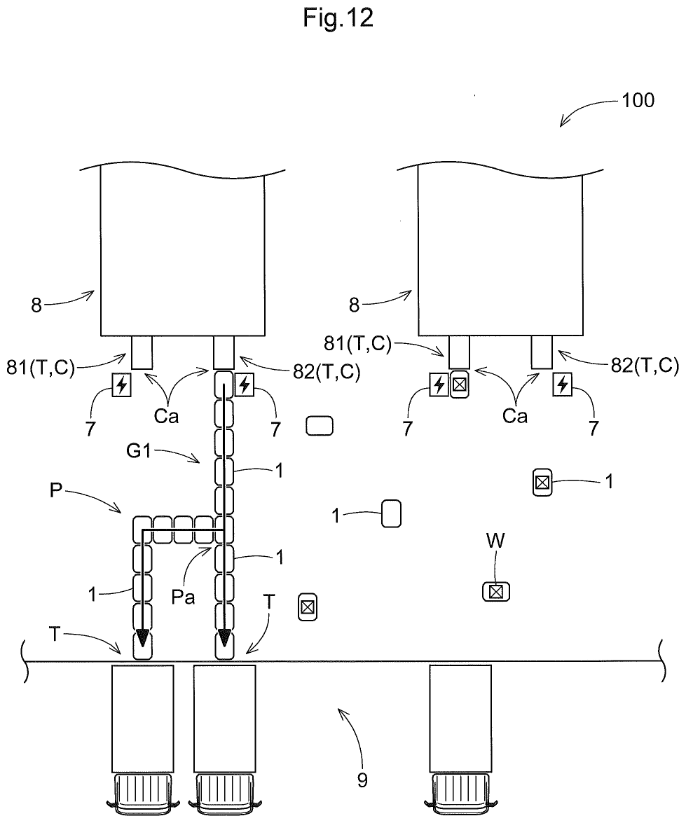

As shown in FIG. 12, the host control device H of this embodiment is configured to selectively change the configuration of the transport route P for the combined transport vehicle group G1 connected to the connection target location C. For example, the host control device H may add at least one of a serial configuration, a branching configuration, and a merging configuration to the current transport configuration of the transport route P for the combined transport vehicle group G1 connected to the connection target location C. Alternatively, at least one of the serial configuration, the branching configuration, and the merging configuration may be deleted from the current transport configuration of the transport route P.

In the example shown in FIG. 12, the host control device H controls the combined transport vehicle group G1 to add a branching configuration by providing a branching section Pa to the transport route P, which is in a serial configuration extending in a straight line from the unloading section 82 serving as the connection target location C. The two transport routes P downstream of the branching section Pa are respectively connected to different transfer target locations T. This makes it possible to distribute a plurality of articles W to be transported from the unloading section 82 by the combined transport vehicle group G1 to the plurality of transfer target locations T, for example, when a large number of articles W are to be unloaded from the automated warehouse 8. Although detailed illustration is omitted, the host control device H may control the combined transport vehicle group G1 to add a merging configuration by providing a merging section Pb to the transport route P that is in a serial configuration extending in a straight line from the unloading section 82 serving as the connection target location C.

As described above, the article transport facility 100 is provided with a plurality of power supply sections 7 that supply power to the transport vehicles 1. In this embodiment, at least one of the plurality of power supply sections 7 is provided at a position adjacent to the connection target location C. This makes it possible to supply power to the combined transport vehicle group G1 or the individual transport vehicle 1 connected to the connection target location C during the stopped state, by taking advantage of the fact that the combined transport vehicle group G1 or the individual transport vehicle 1 is stopped.

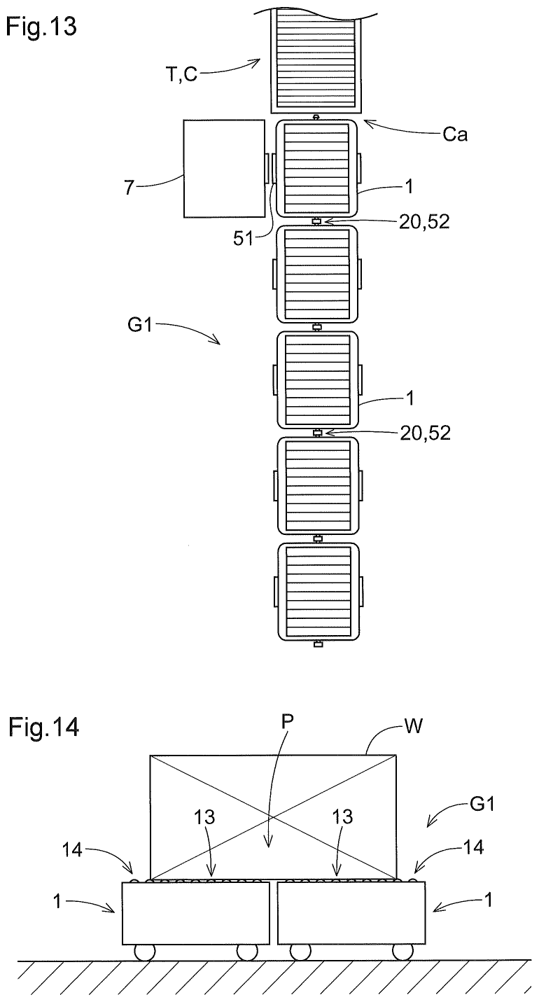

As shown in FIG. 13, a power-receiving transport vehicle 1 of this embodiment, which is at least one of the transport vehicles 1 in the combined transport vehicle group G1, is configured to receive power from a power supply section 7. In this example, the power-receiving transport vehicle 1 is the transport vehicle 1 disposed at the adjacent position Ca of the connection target location C among the plurality of transport vehicles 1 that constitute the combined transport vehicle group G1. Then, the plurality of transport vehicles 1 that constitute the combined transport vehicle group G1 are electrically connected to each other by the power transmission section 52 (i.e., via the power transmission section 52) such that the remaining transport vehicles 1 in the combined transport vehicle group G1 receive a supply of power from the power-receiving transport vehicle 1.

The power-receiving transport vehicle 1 of this embodiment is configured to receive a supply of power from the power supply section 7 in a non-contacting manner. As described above, the power lines of the power transmission sections 52 are provided in the coupling sections 20 that couple adjacent transport vehicles 1 to each other. Accordingly, the transport vehicles 1 other than the power-receiving transport vehicle 1 are configured to transmit and receive power via the coupling sections 20 to and from other adjacent transport vehicles 1. The plurality of transport vehicles 1 other than the power-receiving transport vehicle 1 of this example are configured to transmit and receive power to and from each other during a period in which the power-receiving transport vehicle 1 is receiving power from the power supply section 7.

With this configuration, it is possible to charge the plurality of transport vehicles 1 that constitute the combined transport vehicle group G1 at the same time. Also, since the power supply section 7 need only supply power to at least one of the transport vehicles 1 in the combined transport vehicle group G1, it is not necessary to directly supply power to all of the plurality of transport vehicles 1 that constitute the combined transport vehicle group G1. For this reason, the power supply section 7 can be made smaller. Also, by making it possible to reduce the size of the power supply section 7, the flexibility in disposing the power supply section 7 is improved.

### Other Embodiments

Next, other embodiments will be described.

(1) The above embodiment described an example in which a plurality of transport vehicles 1 are combined so as to be adjacent to each other to constitute a combined transport vehicle group G1, and the plurality of transport vehicles 1 constitute a transport route P in which the transfer sections 14 of the transport vehicles 1 cooperate to transport articles W. This combined transport vehicle group G1 need only be constituted by two or more transport vehicles 1. For example, as shown in FIG. 14, two transport vehicles 1 may constitute a combined transport vehicle group G1. In this case, a transport route P is formed by the transfer sections 14 of the two transport vehicles 1. This configuration is suitable when transporting articles W of a size or number that cannot be transported by a single transport vehicle 1 to a specific location.

(2) The above embodiment described an example in which a plurality of transport vehicles 1 are combined to constitute the combined transport vehicle group G1 by coupling the coupling sections 20 of the transport vehicles 1. However, there is no limitation to this example, and the plurality of transport vehicles 1 do not need to be physically connected, and may approach each other to constitute a combined transport vehicle group G1. In this case, while the plurality of transport vehicles 1 are combined, the plurality of transport vehicles 1 may travel in synchronization with each other while maintaining the combined state. The control units H1 included in the transport vehicles 1 communicate with each other so that the transport vehicles 1 are linked with each other and travel in synchronization with each other. Note that some of the plurality of transport vehicles 1 that constitute the combined transport vehicle group G1 may be combined using the coupling sections 20, and others may be combined by being synchronized under control.

(3) The above embodiment described an example in which a gap is formed between the transport vehicle 1 arranged at the adjacent position Ca and the connection target location C while the combined transport vehicle group G1 is in the connected state. However, there is no limitation to this example, and the transport vehicle 1 arranged at the adjacent position Ca and the connection target location C may be physically connected so as not to have a gap.

(4) The above embodiment described an example in which a plurality of transport vehicles 1 are arranged side by side in a line to form a single transport route P and to constitute a combined transport vehicle group G1. However, there is no limitation to this example, and a plurality of transport vehicles 1 may be arranged side by side in two or more lines to form one transport route P and to constitute a combined transport vehicle group G1. In this case, the transport route P is wider than a route formed by a plurality of transport vehicles 1 in a single line.

(5) In the above embodiment, a loading section 81 and an unloading section 82 are given as examples of connection target locations C. However, there is no limitation to this example, and the connection target location C need only be a location to which a transport vehicle 1 is connected to transfer an article W. Examples of other connection target locations C include boundaries of work areas where various tasks are performed and transport devices other than the transport vehicle 1.

(6) The above embodiment described an example in which a plurality of transport vehicles 1 other than the power-receiving transport vehicle 1 are configured to transmit and receive power to and from each other during a period in which the power-receiving transport vehicle 1 is receiving power from a power supply section 7. However, there is no limitation to this example, and the power-receiving transport vehicle 1 may receive a sufficient supply of power from the power supply section 7 and store the received power, and after the entire combined transport vehicle group G1 has moved away from the power supply section 7, a plurality of transport vehicles 1 other than the power-receiving transport vehicle 1 may receive a supply of power from the power-receiving transport vehicle 1 and transmit and receive power to and from each other. In this case, it is preferable that the power-receiving transport vehicle 1 is equipped with a large-capacity battery that can be charged quickly.

(7) The above embodiment described an example in which the power reception section 51 of the transport vehicle 1 is constituted using a power reception pad, and the transport vehicle 1 is configured to receive a supply of power in a non-contacting manner from a power supply section 7 including a power transmission pad. However, there is no limitation to this example, and the transport vehicle 1 may be configured to receive a supply of power from the power supply section 7 while connected thereto via a power line.

(8) The above embodiment described an example in which the transport vehicles 1 that constitute the combined transport vehicle group G1 are electrically connected to each other by the power transmission sections 52 that transmit power to the other transport vehicles 1 in a contacting manner. However, there is no limitation to this example, and the transport vehicles 1 that constitute the combined transport vehicle group G1 may be electrically connected to each other by power transmission sections 52 that transmit power to the other transport vehicles 1 in a non-contacting manner.

(9) Note that the configurations disclosed in the above embodiments can be combined with configurations disclosed in other embodiments as long as no contradiction arises. Regarding other configurations as well, the embodiments disclosed in this specification are merely examples in all respects. Accordingly, various modifications can be made as appropriate without departing from the spirit of the present disclosure.

### Summary of the Present Embodiment

The following is a summary of the present embodiment.

An article transport facility including:
a plurality of transport vehicles configured to transport an article by traveling on a travel surface without a track;
a plurality of connection target locations to which the transport vehicles are connectable; and
a control system configured to control the plurality of transport vehicles,
in which each of the transport vehicles includes
   a placement section on which the article is placeable, and
   a transfer section configured to transfer the article placed on the placement section,
in a combined state in which the plurality of transport vehicles are combined in such a manner as to be adjacent to each other, the plurality of transport vehicles constitute a transport route in which the plurality of transfer sections cooperate to transport the article,
the plurality of transport vehicles in the combined state form a combined transport vehicle group,
the combined transport vehicle group enters a connected state in which the article is deliverable to and from a connection target location of the plurality of connection target locations, due to at least one of the plurality of transport vehicles in the combined transport vehicle group being disposed at an adjacent position adjacent to the connection target location,
the plurality of connection target locations include a first connection target location and a second connection target location at a position different from that of the first connection target location, and
the control system is configured to move the combined transport vehicle group between the adjacent position adjacent to the first connection target location and the adjacent position adjacent to the second connection target location while maintaining the plurality of transport vehicles in the combined state.

According to this configuration, each transport vehicle can transport an article to various locations alone, and a plurality of transport vehicles can be combined to transport an article along a continuous transport route. That is, it is possible to use the transport vehicles to realize a transport configuration in which a specific article is transported to a specific location and a transport configuration in which a plurality of articles are continuously transported to the same location. Furthermore, the combined transport vehicle group can use the placement sections of the plurality of transport vehicles that constitute the combined transport vehicle group to place articles of a size or number that cannot be transported by a single transport vehicle. The combined transport vehicle group can then move between the plurality of connection target locations while maintaining the combined state. Accordingly, articles of a size or number that cannot be transported by a single transport vehicle can be transported between a plurality of connection target locations. As described above, according to the present configuration, it is possible to flexibly change the article transport configuration.

It is preferable that each of the connection target locations includes a conveyor, and
in a case of putting the combined transport vehicle group in the connected state, the control system disposes at least one of the transport vehicles in the combined transport vehicle group at the adjacent position by moving the combined transport vehicle group to approach the adjacent position along a conveyor transport direction that is a direction for transport of the article by the conveyor.

According to this configuration, in a case where, for example, the transport vehicle located at the adjacent position is the transport vehicle at one end of the combined transport vehicle group, it is easy to appropriately align the direction in which articles are transported by the conveyor at the connection target location with the direction in which articles are transported by each transport vehicle that constitutes the combined transport vehicle group. Also, it is possible to easily realize a state in which the combined transport vehicle group is connected to the connection target location.

It is preferable that the control system is configured to selectively cause the combined transport vehicle group to form a serial configuration in which the transport route is one route, a branching configuration in which at least one location on the transport route is provided with a branching section where one route branches into two or more routes, and a merging configuration in which at least one location on the transport route is provided with a merging section where two or more routes merge into one route.

According to this configuration, it is easy to flexibly set the shape of the transport route constituted by the transfer sections of the plurality of transport vehicles. Also, the flexibility in transport is improved.

It is preferable that the article transport facility further includes a power supply section configured to supply power to the transport vehicles while fixed at a position on the travel surface,
in which each of the plurality of transport vehicles includes a power transmission section configured to transmit power to another transport vehicle of the plurality of transport vehicles while combined with the other transport vehicle,
the combined transport vehicle group includes at least one transport vehicle serving as a power-receiving transport vehicle, and the power-receiving transport vehicle receives a supply of power from the power supply section, and
the plurality of transport vehicles constituting the combined transport vehicle group are electrically connected to each other by the power transmission sections in such a manner that a remaining transport vehicle of the plurality of transport vehicles in the combined transport vehicle group receives a supply of power from the power-receiving transport vehicle.

According to this configuration, it is possible to charge the plurality of transport vehicles that constitute the combined transport vehicle group at the same time. Also, the power supply section need only supply power to at least one of the transport vehicles in the combined transport vehicle group, and does not need to directly supply power to all of the plurality of transport vehicles that constitute the combined transport vehicle group. For this reason, it is easy to reduce the size of the power supply section and simplify the configuration of the power supply section.

### Industrial Applicability

The technology disclosed herein can be used in an article transport facility that includes a plurality of transport vehicles that travel without tracks on a travel surface to transport articles.

What is claimed is:

1. An article transport facility comprising:
a plurality of transport vehicles configured to transport an article by traveling on a travel surface without a track;
a plurality of connection target locations to which the transport vehicles are connectable; and
a control system configured to control the plurality of transport vehicles, and
wherein:
each of the transport vehicles comprises:
a placement section on which the article is placeable, and
a transfer section configured to transfer the article placed on the placement section,
in a combined state in which the plurality of transport vehicles are combined in such a manner as to be adjacent to each other, the plurality of transport vehicles constitute a transport route in which the plurality of transfer sections cooperate to transport the article,
the plurality of transport vehicles in the combined state form a combined transport vehicle group,
the combined transport vehicle group enters a connected state in which the article is deliverable to and from a connection target location of the plurality of connection target locations, due to at least one of the plurality of transport vehicles in the combined transport vehicle group being disposed at an adjacent position adjacent to the connection target location,
the plurality of connection target locations comprise a first connection target location and a second connection target location at a position different from that of the first connection target location, and
the control system is configured to move the combined transport vehicle group between the adjacent position adjacent to the first connection target location and the adjacent position adjacent to the second connection target location while maintaining the plurality of transport vehicles in the combined state.

2. The article transport facility according to claim 1,
wherein each of the connection target locations comprise a conveyor, and
wherein in a case of putting the combined transport vehicle group in the connected state, the control system disposes at least one of the transport vehicles in the combined transport vehicle group at the adjacent position by moving the combined transport vehicle group to approach the adjacent position along a conveyor transport direction that is a direction for transport of the article by the conveyor.

3. The article transport facility according to claim 1,
wherein the control system is configured to selectively cause the combined transport vehicle group to form a serial configuration in which the transport route is one route, a branching configuration in which at least one location on the transport route is provided with a branching section where one route branches into two or more routes, and a merging configuration in which at least one location on the transport route is provided with a merging section where two or more routes merge into one route.

4. The article transport facility according to claim 1, further comprising:
a power supply section configured to supply power to the transport vehicles while fixed at a position on the travel surface, and
wherein:
each of the plurality of transport vehicles comprises a power transmission section configured to transmit power to another transport vehicle of the plurality of transport vehicles while combined with the other transport vehicle,
the combined transport vehicle group comprises at least one transport vehicle serving as a power-receiving transport vehicle, and the power-receiving transport vehicle receives a supply of power from the power supply section, and
the plurality of transport vehicles constituting the combined transport vehicle group are electrically connected to each other by the power transmission sections in such a manner that a remaining transport vehicle of the plurality of transport vehicles in the combined transport vehicle group receives a supply of power from the power-receiving transport vehicle.
